(19) United States
(12) Patent Application Publication
(10) Pub. No.: US 2026/0158995 A1
(43) Pub. Date: Jun. 11, 2026

(54) VEHICULAR TRAILERING ASSIST SYSTEM WITH HITCH POINT DETECTION

(71) Applicant: Magna Electronics Inc., Auburn Hills, MI (US)

(72) Inventors: Jyothi P. Gali, Rochester Hills, MI (US); Prasanna Ananthakrishnan, Tamilnadu (IN); Sharad Benakatti, Bangalore (IN)

(21) Appl. No.: 19/413,023

(22) Filed: Dec. 9, 2025

Related U.S. Application Data
(60) Provisional application No. 63/730,018, filed on Dec. 10, 2024.

(51) Int. Cl. B60R 1/00; B60D 1/62; B60R 1/26

(52) U.S. Cl. CPC B60R 1/003; B60D 1/62; B60R 1/26; B60R 2300/30; B60R 2300/808

(57) ABSTRACT

A vehicular trailering assist system includes a camera at a vehicle operable to capture image data of a trailer hitched to the vehicle. The system, during a driving maneuver, and via processing frames of image data, determines locations in the frames of a target at the trailer. The system determines real-world coordinates of the target that correspond to the determined locations in the frames of image data. The system determines a first intersection line between the real-world coordinates corresponding to first and second frames and a first line perpendicular to the first intersection line. The system determines a second intersection line between the real-world coordinates corresponding to third and fourth frames and a second line perpendicular to the second intersection line. The system determines a pivot point of the trailer based on an intersection of the first and second perpendicular lines.

### CROSS REFERENCE TO RELATED APPLICATION

The present application claims the filing benefits of U.S. provisional application Ser. No. 63/730,018, filed Dec. 10, 2024, which is hereby incorporated herein by reference in its entirety.

### FIELD OF THE INVENTION

The present invention relates generally to a vehicle trailering assist system for a vehicle and, more particularly, to a vehicle trailering assist system that utilizes one or more cameras at a vehicle.

### BACKGROUND OF THE INVENTION

Use of imaging sensors in vehicular trailer assist systems is common and known. Examples of such known systems are described in U.S. Pat. Nos. 9,446,713 and 9,085,261, which are hereby incorporated herein by reference in their entireties.

### SUMMARY OF THE INVENTION

A vehicular trailering assist system includes a camera disposed at a vehicle equipped with the vehicular trailering assist system and viewing exterior of the equipped vehicle. The camera is operable to capture image data representative of at least a portion of a trailer hitched to the equipped vehicle. The camera includes an imager, and the imager includes a CMOS imaging array having at least one million photosensors arranged in rows and columns. Image data captured by the camera is transferred to an electronic control unit (ECU). The ECU includes electronic circuitry and associated software, and the electronic circuitry of the ECU includes an image processor operable to process image data transferred to the ECU. The vehicular trailering assist system, during a driving maneuver of the equipped vehicle with the trailer hitched to the equipped vehicle, and via processing at the ECU of frames of image data captured by the camera during the driving maneuver, determines locations in the respective frames of image data of a target disposed at the trailer. The vehicular trailering assist system determines real-world coordinates of the target relative to the vehicle that correspond to the determined locations of the target in the respective frames of image data. The vehicular trailering assist system determines a first triangle including (i) a first intersection line extending between the real-world coordinate of the target corresponding to a first frame of image data and the real-world coordinate of the target corresponding to a second frame of image data and (ii) a first perpendicular line extending perpendicular to the first intersection line. The vehicular trailering assist system determines a second triangle including (i) a second intersection line extending between the real-world coordinate of the target corresponding to a third frame of image data and the real-world coordinate of the target corresponding to a fourth frame of image data and (ii) a second perpendicular line extending perpendicular to the second intersection line. The vehicular trailering assist system determines a pivot point of the trailer relative to the equipped vehicle based on an intersection point of the first perpendicular line and the second perpendicular line. Optionally, the vehicular trailering assist system determines a trailer angle of the trailer relative to the equipped vehicle based on the determined pivot point of the trailer relative to the equipped vehicle, such as to aid in determining a path of travel for the vehicle and the trailer as the vehicle and trailer maneuver in a rearward direction.

These and other objects, advantages, purposes and features of the present invention will become apparent upon review of the following specification in conjunction with the drawings.

### BRIEF DESCRIPTION OF THE DRAWINGS

FIG. 1 a plan view of a vehicle with a trailering assist system that is operable to determine a trailer angle of a trailer relative to the vehicle;

FIGS. 2A-2E are schematic views of the trailering assist system determining a pivot point of the trailer relative to the vehicle based on tracking a target at the trailer in frames of image data as the trailer pivots relative to the vehicle; and

FIG. 3 is a flowchart of an example method of determining the pivot point of the trailer relative to the vehicle.

### DESCRIPTION OF THE PREFERRED EMBODIMENTS

The implementation of vision-based tracking for gooseneck and fifth wheel trailers is essential for the functionality of trailer backup assistant systems. Traditional physical sensors used to determine the trailer angle are not only expensive but also susceptible to environmental conditions. To address these limitations, implementations herein include a camera-based solution that determines the trailer angle relative to the towing vehicle. This trailer angle is then utilized to plan the vehicle's trajectory during the operation of the trailer backup system.

A vehicle and trailer maneuvering system or trailering assist system and/or driving assist system operates to capture images exterior of the vehicle and representative of a trailer being towed by the vehicle and may process the captured image data to determine a path of travel for the vehicle and trailer and to detect objects at or near the vehicle and in the predicted path of the vehicle, such as to assist a driver of the vehicle in maneuvering the vehicle and trailer in a rearward direction. The system includes an image processor or image processing system that is operable to receive image data from one or more cameras and may provide an output to a display device for displaying images representative of the captured image data. Optionally, the vision system may provide display, such as a rearview display or a top down or bird's eye or surround view display or the like.

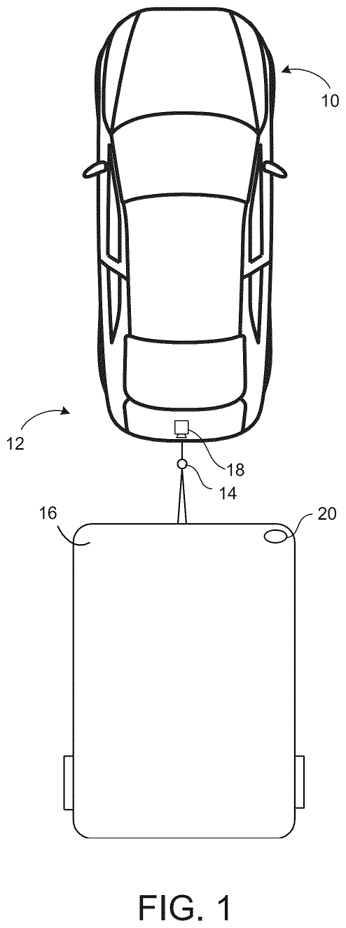

Referring now to the drawings and the illustrative embodiments depicted therein, a vehicle 10 includes a trailering assist system 12 that is operable to assist in backing up or reversing with a hitched trailer via, for example, a hitch 14 and may maneuver the vehicle 10 and trailer 16 toward a desired or selected location. The trailering assist system 12 includes at least one exterior viewing vehicle-based imaging sensor or camera, such as a rearward viewing imaging sensor or camera 18 (and the system may optionally include multiple exterior viewing imaging sensors or cameras, such as a sideward/rearward viewing camera at respective sides of the vehicle), which captures image data representative of the scene exterior of the vehicle 10, which includes the hitch 14 and/or trailer 16, with the camera 18 having a lens for focusing images at or onto an imaging array or imaging plane or imager of the camera (FIG. 1). Optionally, the camera is a center-high-mounted stop lamp (CHMSL) camera. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The trailer maneuver assist system 12 includes a control or electronic control unit (ECU) or processor that is operable to process image data captured by the camera or cameras and may detect objects or the like and/or provide displayed images at a display device for viewing by the driver of the vehicle (the control and/or display device may be part of or incorporated in or at an interior rearview mirror assembly of the vehicle, or the control and/or the display device may be disposed elsewhere at or in the vehicle). The data transfer or signal communication from the camera to the ECU may comprise any suitable data or communication link, such as a vehicle network bus or the like of the equipped vehicle.

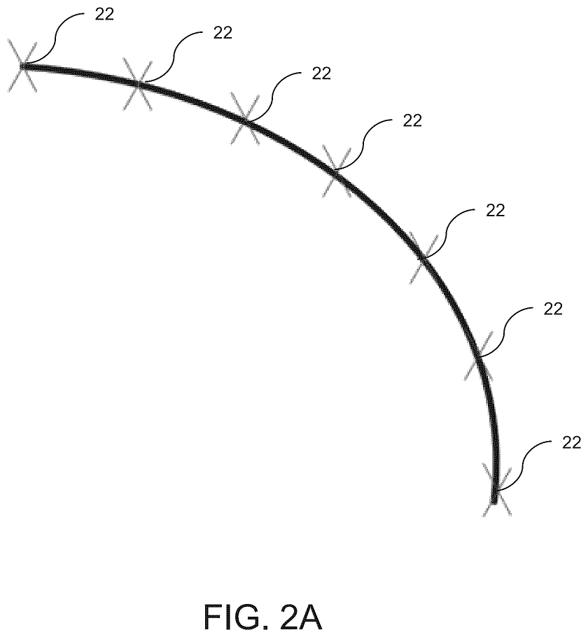

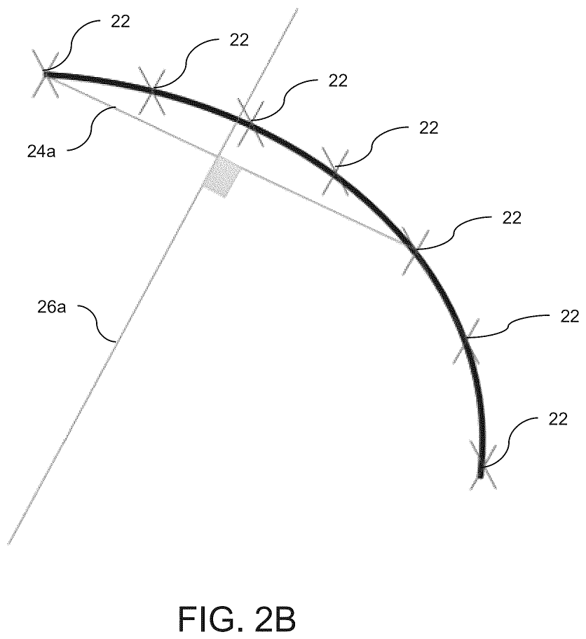

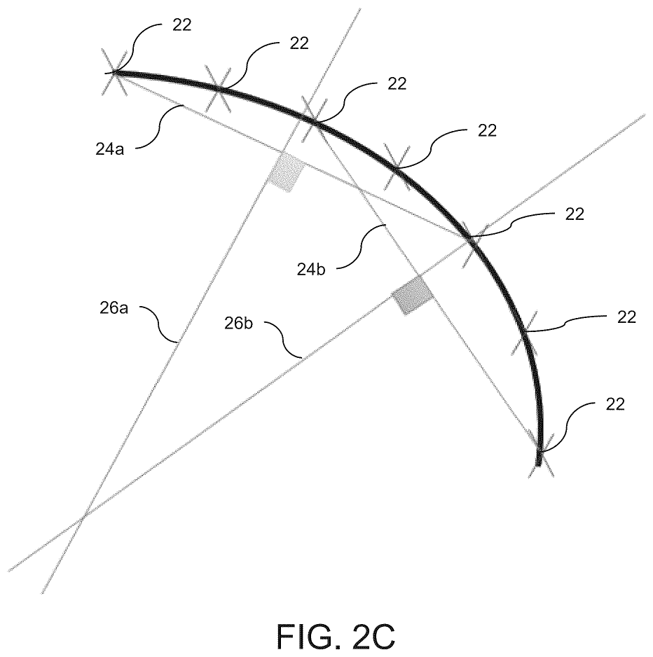

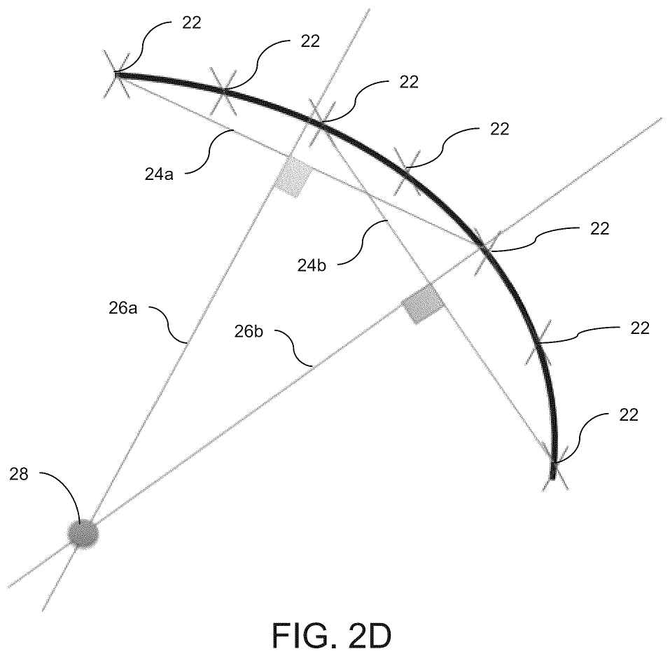

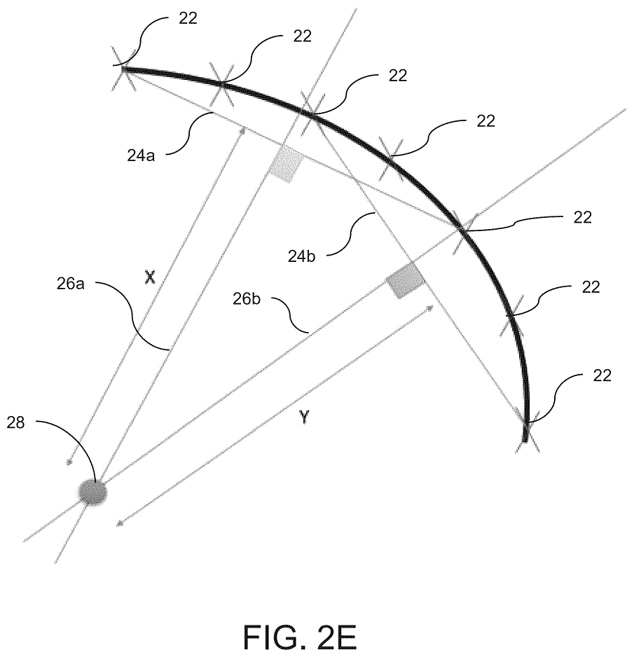

Determining the angle of the trailer 16 with respect to the vehicle 10 is essential for path planning while reversing the vehicle 10 and the trailer 16. Accuracy of the determined trailer angle may be dependent upon determining a pivot point of the trailer 16 relative to the vehicle 10, such as where the hitch 14 of the trailer 16 attaches to the vehicle 10 (e.g., at a hitch ball of the vehicle). Thus, determining the pivot point of the trailer 16 relative to the vehicle 10 may improve path planning. As discussed further below, keypoints or reference markers or targets 20 (e.g., FIG. 1) may be detected on the trailer 16 to detect the position of the pivot point (e.g., where the hitch 14 of the trailer 16 attaches to the hitch ball of the vehicle) relative to the trailer 16. Positions 22 (e.g., FIG. 2A) of the respective keypoints 20 may be stored in a buffer as the trailer 16 pivots or rotates relative to the vehicle 10 and the keypoint positions 22 are triangulated, with the intersection of the triangle determined as the hitch ball or pivot point position.

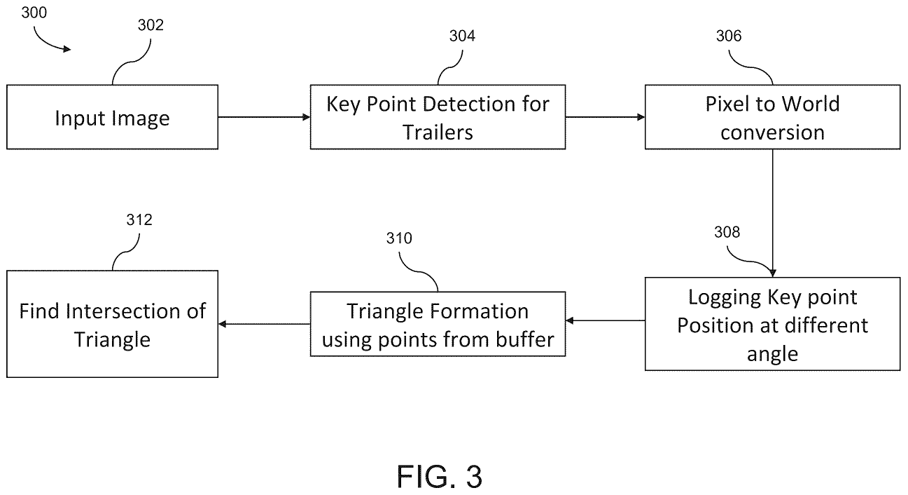

FIGS. 2A-2E schematically show an example of determining the pivot point of the trailer 16 relative to the vehicle 10 by tracking keypoints 20 detected in frames of image data at the trailer 16 as the trailer 16 pivots relative to the vehicle 10 between respective frames of image data. The illustrated example of FIGS. 2A-2E will be discussed in relation to the method 300 of FIG. 3. FIG. 3 provides a flowchart of an example arrangement of operations for a method 300 of determining the pivot point of the trailer 16 relative to the vehicle 10 based on image data captured by the camera 18 of the vehicle 10 as the trailer 16 pivots relative to the vehicle 10. For example, with the trailer 16 hitched to the vehicle 10, the system 12 may perform a calibration sequence where the vehicle 10 is moved to cause the trailer 16 to move and/or pivot relative to the vehicle 10 and the camera 18 captures image data to track movement of the trailer 16 relative to the vehicle during the calibration sequence. Optionally, the system 12 may instruct the driver of the vehicle to perform the calibration sequence.

At operation 302, the method 300 includes receiving one or more frames of image data captured by the camera 18. At operation 304, the method 300 includes detecting one or more keypoints 20 on the trailer 16. For example, the keypoints 20 may include labels or decals strategically placed on the outer surface of the trailer 16 (e.g., at corners and/or the front end of the trailer to be visible to the camera 18) and/or pre-existing portions of the trailer 16 that are identifiable in the image data such as designs, edges, corners, bolts or other fasteners and the like. The system 12 and keypoints 20 may utilize characteristics of the trailering assist systems described in U.S. patent application Ser. No. 19/361,194, filed Oct. 17, 2025 (Attorney Docket MAG04 P5475), which is hereby incorporated herein by reference in its entirety.

The system 12 processes the image data captured by the camera 18 to detect the one or more keypoints 20 in the image data and determine respective pixel positions of the keypoints 20 in the image data. At operation 306, the method 300 includes converting a pixel position of at least one keypoint 20 in a frame of image data to a world coordinate or keypoint position 22, such as based on a predefined reference height. The world coordinate of the keypoint 20 in the frame of image data is stored in a buffer.

As the trailer 16 pivots relative to the vehicle 10, the keypoint 20 moves between subsequent frames of image data. For example, the keypoint 20 may pivot or rotate in a circular motion with a common center (FIG. 2A). At operation 308, the method 300 includes logging keypoint positions 22 (in real-world coordinates) at various angles of the keypoint 20 relative to the vehicle 10. For example, the keypoint positions 22 may be stored in the buffer in increments of 0.5 degrees, 1 degree, 2 degrees and the like. A kinematic trailer angle may be used to determine trailer rotation between frames of image data. It should be understood that the system 12 may be configured to detect movement of the trailer 16 relative to the vehicle and thus determine the position of the pivot point of the trailer by tracking one single keypoint 20 between frames of image data. However, the system 12 may simultaneously track a plurality of keypoints 20, such as to improve accuracy of the trailer angle detection.

The system 12 may track the keypoint 20 between frames of image data and log the position 22 of the keypoint 20 in the buffer until enough keypoint positions 22 are logged. For example, the system 12 may track the keypoint 20 in 1 degree increments until 25 or more keypoint positions 22 are stored in the buffer. Based on the keypoint positions 22 stored in the buffer, the method 300 includes at operation 310 triangulating the keypoint positions 22.

As shown in FIGS. 2B-2E, triangulating the keypoint positions 22 may include forming a line 24a between and intersecting keypoint positions 22 with a given interval between the keypoint positions 22, such as an interval of one keypoint position and thus 1 degree, an interval of two keypoint positions and thus 2 degrees, an interval of three keypoint positions and thus 3 degrees and the like. A midpoint of the intersection line 24a is taken and a line 26a is drawn perpendicular to the intersection line 24a and through the midpoint of the intersection line 24a. The intersection line 24a and the perpendicular line 26a may form a pair of right-angle triangles when the perpendicular line 26a is connected to the keypoint positions 22 (FIG. 2B). This process may be repeated to form another intersection line 24b through different keypoint positions 22 from the first intersection line 24a and to form another perpendicular line 26b through the midpoint of the second intersection line 24b (FIG. 2C). In other words, the intersection line 24b is formed with different keypoint positions 22 from the first intersection line 24a. Although shown as determining two intersection lines 24a, 24b and two perpendicular lines 26a, 26b based on two different combinations of the keypoint positions 22, it should be understood that the system 12 may determine more than two pairs of intersection lines and perpendicular lines, such as three or more, four or more, or any suitable number up to each possible combination of keypoint positions 22.

At operation 312, the method 300 includes determining an intersection point 28 of one or more of the determined perpendicular lines (FIG. 2D). The intersection point 28 may comprise or represent the pivot point of the trailer 16 relative to the vehicle 10.

Optionally, the system 12 may verify or validate the determined hitch point. For example, once the intersection point 28 is determined, a distance X between the intersection point 28 and the first intersection line 24a and a distance Y between the intersection point 28 and the second intersection line 24b are determined (FIG. 2E). Since the trailer 16 moves in a circular motion, the distance X and the distance Y should be the same for both triangles. If the distance X and the distance Y vary (such as more than a threshold amount like 1 millimeter, 10 millimeters, 100 millimeters and the like), the intersection point 28 may be determined invalid and the process may be repeated to find an accurate pivot point.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of the trailering assist systems or trailer angle detection systems or trailer hitch assist systems described in U.S. Pat. Nos. 12,071,132; 11,964,689; 11,787,339; 11,613,210; 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0212599; US-2022-0028111; US-2022-0027644; US-2022-0024391; US-2021-0170947; US-2021-0170820; US-2021-0078634; US-2021-0053572; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a camera disposed at a vehicle equipped with the vehicular trailering assist system and viewing exterior of the equipped vehicle;
wherein the camera is operable to capture image data representative of at least a portion of a trailer hitched to the equipped vehicle;
wherein the camera comprises an imager, and wherein the imager comprises a CMOS imaging array having at least one million photosensors arranged in rows and columns;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, during a driving maneuver of the equipped vehicle with the trailer hitched to the equipped vehicle, and via processing at the ECU of frames of image data captured by the camera during the driving maneuver, determines locations in the respective frames of image data of a target disposed at the trailer;
wherein the vehicular trailering assist system determines real-world coordinates of the target relative to the vehicle that correspond to the determined locations of the target in the respective frames of image data;
wherein the vehicular trailering assist system determines (i) a first intersection line extending between the real-world coordinate of the target corresponding to a first frame of image data and the real-world coordinate of the target corresponding to a second frame of image data and (ii) a first perpendicular line extending perpendicular to the first intersection line;
wherein the vehicular trailering assist system determines (i) a second intersection line extending between the real-world coordinate of the target corresponding to a third frame of image data and the real-world coordinate of the target corresponding to a fourth frame of image data and (ii) a second perpendicular line extending perpendicular to the second intersection line;
wherein the vehicular trailering assist system determines a pivot point of the trailer relative to the equipped vehicle based on an intersection point of the first perpendicular line and the second perpendicular line; and
wherein the vehicular trailering assist system determines a trailer angle of the trailer relative to the equipped vehicle based on the determined pivot point of the trailer relative to the equipped vehicle.

2. The vehicular trailering assist system of claim 1, wherein the trailer pivots relative to the vehicle during the driving maneuver.

3. The vehicular trailering assist system of claim 1, wherein the vehicular trailering assist system stores the real-world coordinates of the target in a buffer.

4. The vehicular trailering assist system of claim 3, wherein the vehicular trailering assist system stores the real-world coordinates of the target in the buffer at least until a threshold number of different real-world coordinates are stored.

5. The vehicular trailering assist system of claim 3, wherein the vehicular trailering assist system stores the real-world coordinates of the target in the buffer in pivotal increments of the trailer relative to the vehicle.

6. The vehicular trailering assist system of claim 1, wherein the vehicular trailering assist system determines (i) a first distance of the first perpendicular line between the intersection point and the first intersection line and (ii) a second distance of the second perpendicular line between the intersection point and the second intersection line, and wherein the vehicular trailering assist system invalidates the determined pivot point of the trailer relative to the equipped vehicle responsive to a difference between the first distance and the second distance being greater than a threshold difference.

7. The vehicular trailering assist system of claim 1, wherein the target comprises a decal disposed at the trailer.

8. The vehicular trailering assist system of claim 1, wherein the target comprises a pre-existing portion of the trailer.

9. The vehicular trailering assist system of claim 1, wherein the vehicular trailering assist system determines the real-world coordinates of the target based on converting pixel coordinates to real-world coordinates.

10. The vehicular trailering assist system of claim 1, wherein the trailer comprises one selected from the group consisting of (i) a gooseneck trailer and (ii) a fifth wheel trailer.

11. A vehicular trailering assist system, the vehicular trailering assist system comprising:
a camera disposed at a vehicle equipped with the vehicular trailering assist system and viewing exterior of the equipped vehicle;
wherein the camera is operable to capture image data representative of at least a portion of a trailer hitched to the equipped vehicle;
wherein the camera comprises an imager, and wherein the imager comprises a CMOS imaging array having at least one million photosensors arranged in rows and columns;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, during a driving maneuver of the equipped vehicle with the trailer hitched to the equipped vehicle, and with the trailer pivoting relative to the vehicle during the driving maneuver, and via processing at the ECU of frames of image data captured by the camera during the driving maneuver, determines locations in the respective frames of image data of a target disposed at the trailer;
wherein the vehicular trailering assist system determines real-world coordinates of the target relative to the vehicle that correspond to the determined locations of the target in the respective frames of image data;
wherein the vehicular trailering assist system determines the real-world coordinates of the target based on converting pixel coordinates to real-world coordinates;
wherein the vehicular trailering assist system determines (i) a first intersection line extending between the real-world coordinate of the target corresponding to a first frame of image data and the real-world coordinate of the target corresponding to a second frame of image data and (ii) a first perpendicular line extending perpendicular to the first intersection line;
wherein the vehicular trailering assist system determines (i) a second intersection line extending between the real-world coordinate of the target corresponding to a third frame of image data and the real-world coordinate of the target corresponding to a fourth frame of image data and (ii) a second perpendicular line extending perpendicular to the second intersection line;
wherein the vehicular trailering assist system determines (i) a third intersection line extending between the real-world coordinate of the target corresponding to a fifth frame of image data and the real-world coordinate of the target corresponding to a sixth frame of image data and (ii) a third perpendicular line extending perpendicular to the third intersection line;
wherein the vehicular trailering assist system determines a pivot point of the trailer relative to the equipped vehicle based on an intersection point of at least two selected from the group consisting of (i) the first perpendicular line, (ii) the second perpendicular line and (iii) the third perpendicular line; and
wherein the vehicular trailering assist system determines a trailer angle of the trailer relative to the equipped vehicle based on the determined pivot point of the trailer relative to the equipped vehicle.

12. The vehicular trailering assist system of claim 11, wherein the vehicular trailering assist system determines (i) a first distance of the first perpendicular line between the intersection point and the first intersection line, (ii) a second distance of the second perpendicular line between the intersection point and the second intersection line and (iii) a third distance of the third perpendicular line between the intersection point and the third intersection line, and wherein the vehicular trailering assist system invalidates the determined pivot point of the trailer relative to the equipped vehicle responsive to a difference between any combination of the first distance, the second distance and the third distance being greater than a threshold difference.

13. The vehicular trailering assist system of claim 11, wherein the target comprises a decal disposed at the trailer.

14. The vehicular trailering assist system of claim 11, wherein the target comprises a pre-existing portion of the trailer.

15. The vehicular trailering assist system of claim 11, wherein the trailer comprises one selected from the group consisting of (i) a gooseneck trailer and (ii) a fifth wheel trailer.

16. A vehicular trailering assist system, the vehicular trailering assist system comprising:
a camera disposed at a vehicle equipped with the vehicular trailering assist system and viewing exterior of the equipped vehicle;
wherein the camera is operable to capture image data representative of at least a portion of a trailer hitched to the equipped vehicle;
wherein the camera comprises an imager, and wherein the imager comprises a CMOS imaging array having at least one million photosensors arranged in rows and columns;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU;
wherein the vehicular trailering assist system, during a driving maneuver of the equipped vehicle with the trailer hitched to the equipped vehicle, and with the trailer pivoting relative to the vehicle during the driving maneuver, and via processing at the ECU of frames of image data captured by the camera during the driving maneuver, determines locations in the respective frames of image data of a target disposed at the trailer;
wherein the vehicular trailering assist system determines real-world coordinates of the target relative to the vehicle that correspond to the determined locations of the target in the respective frames of image data;
wherein the vehicular trailering assist system stores the real-world coordinates of the target in a buffer at least until a threshold number of different real-world coordinates are stored, and wherein the vehicular trailering assist system stores the real-world coordinates of the target in the buffer in pivotal increments of the trailer relative to the vehicle;
wherein the vehicular trailering assist system determines (i) a first intersection line extending between the real-world coordinate of the target corresponding to a first frame of image data and the real-world coordinate of the target corresponding to a second frame of image data and (ii) a first perpendicular line extending perpendicular to the first intersection line;
wherein the vehicular trailering assist system determines (i) a second intersection line extending between the real-world coordinate of the target corresponding to a third frame of image data and the real-world coordinate of the target corresponding to a fourth frame of image data and (ii) a second perpendicular line extending perpendicular to the second intersection line;
wherein the vehicular trailering assist system determines a pivot point of the trailer relative to the equipped vehicle based on an intersection point of the first perpendicular line and the second perpendicular line; and
wherein the vehicular trailering assist system determines a trailer angle of the trailer relative to the equipped vehicle based on the determined pivot point of the trailer relative to the equipped vehicle.

17. The vehicular trailering assist system of claim 16, wherein the vehicular trailering assist system determines (i) a first distance of the first perpendicular line between the intersection point and the first intersection line and (ii) a second distance of the second perpendicular line between the intersection point and the second intersection line, and wherein the vehicular trailering assist system invalidates the determined pivot point of the trailer relative to the equipped vehicle responsive to a difference between the first distance and the second distance being greater than a threshold difference.

18. The vehicular trailering assist system of claim 16, wherein the target comprises one selected from the group consisting of (i) a decal disposed at the trailer and (ii) a pre-existing portion of the trailer.

19. The vehicular trailering assist system of claim 16, wherein the vehicular trailering assist system determines the real-world coordinates of the target based on converting pixel coordinates to real-world coordinates.

20. The vehicular trailering assist system of claim 16, wherein the trailer comprises one selected from the group consisting of (i) a gooseneck trailer and (ii) a fifth wheel trailer.
